(19) United States
(12) Patent Application Publication
(10) Pub. No.: US 2006/0036775 A1
(43) Pub. Date: Feb. 16, 2006

(54) Apparatus and methods for video graphics array (VGA) virtualization in system exploiting multiple operating systems

(76) Inventor: Konstantin Levit-Gurevich, Kiryat Byalik (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/918,693

(22) Filed: Aug. 16, 2004

(51) Int. Cl. G06F 3/00

(52) U.S. Cl. 710/1

(57) ABSTRACT

An operating system is prohibited from accessing a video graphics array (VGA) controller. An attempt by the operating system to program the VGA controller to operate in a transparent plane configuration is interrupted, the transparent plane configuration including a specification that a block of image data is to be transferred to a particular bit-plane of the VGA controller. In response to an attempt by the operating system to store the block of image data in the VGA controller, the operating system is caused to store the block of image data in a buffer in a memory without halting execution of the operating system.

### BACKGROUND OF THE INVENTION

An apparatus, for example, a computer, may execute two or more operating systems at the same time. The apparatus may have physical resources, for example, a video graphics array (VGA) controller and a VGA monitor, and more than one of the operating systems may need to access the physical resources.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a block diagram of an exemplary system, including an apparatus and a monitor, and optionally including input devices and audio devices, according to some embodiments of the invention;

FIG. 2 is a block diagram of a simplified exemplary architecture to execute at least one guest operating system while executing a host operating system, according to some embodiments of the invention;

FIG. 3 is a block diagram of a simplified exemplary architecture to provide video graphics array (VGA) virtualization to one guest operating system, according to some embodiments of the invention;

FIG. 4 is a simplified flowchart illustration of an exemplary method for initialization for VGA virtualization, according to some embodiments of the invention; and

FIG. 5 is a simplified flowchart illustration of an exemplary method for VGA virtualization, according to some embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail so as not to obscure the embodiments of the invention.

Some portions of the detailed description which follow are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that may manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. The apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

According to some embodiments of the invention, a system that contains a processor may be able to execute two or more operating systems concurrently. One operating system, denoted here as the “host” operating system (OS), may generate virtual machines, and may encapsulate operation of other operating systems, denoted here as “guest” operating systems, with the virtual machines.

In addition, according to some embodiments of the invention, virtual machine monitor (VMM) code may be executed under control of the host OS, and in conjunction with a hardware extension of the processor, may monitor and manage the operation of the virtual machines. According to some other embodiments of the invention, the VMM code may be external to the host OS, and the host OS itself may or may not exist.

Guest operating systems may allocate logical addresses for accessing physical resources, such as, for example, a video graphics array (VGA) controller. For example, logical memory-space addresses may be allocated for writing image data to a VGA controller, and logical input/output (I/O)-space addresses may be allocated for accessing control elements of the VGA controller, such as a control register file and/or a color palette.

However, to avoid conflicts between operating systems, or for any other reasons, the VMM may prohibit the guest operating system from directly accessing the physical resources. Instead, the VMM may emulate operation of such physical resources and the guest operating systems may access the emulation instead of the physical resources. The VMM may monitor accesses of the guest operating system to the emulation, and may interact with the physical resources in a suitable manner.

In the example of a VGA controller, a guest OS may attempt to send control bits and/or image data to the VGA controller, and the control bits and/or the image data may be received by the emulation instead. In addition, the guest OS may attempt to read control bits from a VGA controller, and the control bits may be read by the guest operating system from the emulation instead.

Architecture of a VGA controller may include a video buffer to receive image data, and may include four bit-plane buffers. Image data received into the video buffer may be transformed by the VGA controller, and the transformed image data may be stored in one or more of the bit-plane buffers. An image may be generated by the VGA controller on a monitor from the transformed image data stored in the bit-plane buffers. For example, in 16-color VGA modes, all four bit-plane buffers are used to store the graphics information. Each pixel is represented by four bits, one bit per bit-plane buffer.

The transformation applied to the image data may be defined, at least in part, by the values stored in a control register file of the VGA controller. Some transformations may involve operations such as rotation, masking and application of one or more functions to the image data. In addition, in some transformations, image data received to the video buffer may affect the content of more than one of the bit-plane buffers.

However, by storing appropriate values in its control register file, a VGA controller may be programmed to operate in a “transparent plane configuration” in which image data received by the video buffer is not transformed and affects the content of only one of the bit-plane buffers. Once in the transparent plane configuration, an identifier of one of the four bit-plane buffers may be written to a control register of the VGA controller, and if afterward image data is written into the video buffer, the image data may be transparently transferred from the video buffer to the identified bit-plane buffer.

According to some embodiments of the invention, the VMM may allocate in memory a virtual control register file, a virtual color palette, and four “shared virtual plane buffers” to emulate the control register file, the color palette, and the four bit-plane buffers of a VGA controller, respectively.

In order to operate a VGA controller in the transparent plane configuration, the guest operating system may write the appropriate control bits to logical I/O-space addresses that are allocated for accessing control elements of the VGA controller. Afterward, the guest operating system may repeatedly write image data blocks to logical memory-space addresses that are allocated for writing image data to a VGA controller. Prior to writing an image data block, the guest operating system may access logical I/O-space addresses that are allocated for accessing control elements of the VGA controller at least once, to specify a bit-plane buffer.

Receiving the bit-plane buffer identifier through the emulation, the VMM may configure the emulation so that image data from the guest operating system is received into the shared virtual plane that corresponds to the identified bit-plane buffer.

In order to operate a VGA controller in a configuration other than the transparent plane configuration, the guest operating system may write the appropriate control bits to the logical I/O-space addresses that are allocated for accessing control elements of the VGA controller. Afterward, the guest operating system may repeatedly write image data blocks to logical memory-space addresses that are allocated for writing image data to a VGA controller, and may in addition write to the logical I/O-space addresses that are allocated for accessing control elements of the VGA controller.

The VMM may identify that image data blocks need to be transformed before being stored in the bit-plane buffers of the VGA controller, and in response to individual accesses of the guest operating system to logical memory-space addresses that are allocated for writing image data to a VGA controller, the VMM may perform corresponding emulations for the accesses.

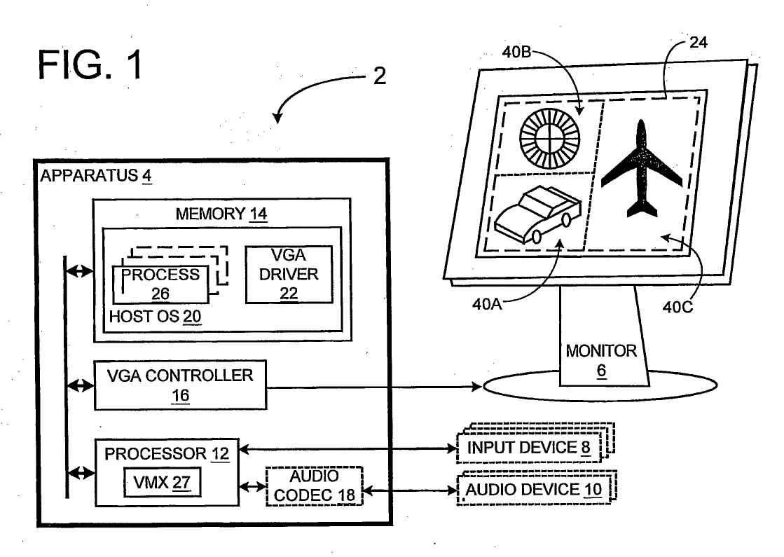

FIG. 1 is a simplified block diagram of an exemplary system 2, including an apparatus 4 and a monitor 6, and optionally including input devices 8 and audio devices 10, according to some embodiments of the invention. Any of monitor 6, input devices 8 and audio devices 10 may or may not be embedded in apparatus 4.

A non-exhaustive list of examples for apparatus 4 includes a desktop personal computer, a work station, a server computer, a hand-held computer, a laptop computer, a notebook computer, and the like. A non-exhaustive list of examples for monitor 6 includes a VGA monitor, a super VGA (SVGA) monitor, and the like. A non-exhaustive list of examples for input devices 8 includes a mouse, a keyboard, a touch screen, a digital pen, and the like. A non-exhaustive list of examples for audio devices 10 includes a microphone, a loudspeaker, an earphone, a headphone, and the like.

Apparatus 4 may include a processor 12, a memory 14 and a VGA controller 16, coupled to one another. In addition, apparatus 4 may include an optional audio coder/decoder (CODEC) 18, coupled to processor 12 and optionally to audio devices 10.

A non-exhaustive list of examples for processor 12 includes a central processing unit (CPU), a digital signal processor (DSP), a reduced instruction set computer (RISC), a complex instruction set computer (CISC) and the like. Moreover, processor 12 may be part of an application specific integrated circuit (ASIC) or may be a part of an application specific standard product (ASSP).

Memory 14 may be fixed in or removable from apparatus 4. A non-exhaustive list of examples for memory 14 includes any combination of the following:
a) removable memories, such as compact flash (CF) memory cards, personal computer memory card international association (PCMCIA) memory cards, security identity module (SIM) cards, MEMORY STICK® cards, universal serial bus (USB) KEY® memory cards, and the like,
b) semiconductor devices, such as read only memory (ROM), mask ROM, electrically erasable programmable read only memory devices (EEPROM), non-volatile random access memory devices (NVRAM), not AND (NAND) flash memory devices, not OR (NOR) flash memory devices, synchronous dynamic random access memory (SDRAM) devices, RAMBUS dynamic random access memory (RDRAM) devices, double data rate (DDR) memory devices, static random access memory (SRAM), and the like,
c) optical devices, such as compact disk read only memory (CD ROM), and the like, and
d) magnetic devices, such as a hard disk, a floppy disk, a magnetic tape, and the like.

Memory 14 may store a host operating system (OS) 20, for example, WINDOWS® XP®, to be executed by processor 12. Host OS 20 may include, for example, a VGA driver 22 to interact with VGA controller 16 and to display image frames, such as an exemplary image frame 24, on monitor 6. One or more processes 26 may be executed by processor 12 under the control of host OS 20.

Apparatus 4, and in particular, processor 12 and host OS 20, may incorporate means to enable processor 12 to execute one or more additional operating systems (denote “guest” operating systems), for example, WINDOWS® XP®, concurrently while executing host OS 20. Such means may be included, for example, in the Vanderpool Technology from Intel Corporation of Santa Clara, Calif., USA. Such means may include, for example, virtual machines (VM) to at least “encapsulate” the operation of guest operating systems, a virtual machine monitor (VMM) to monitor and manage operations of virtual machines, and a virtual machine hardware extension (VMX) 27 in processor 12, to provide communication between the virtual machines and the virtual machine monitor.

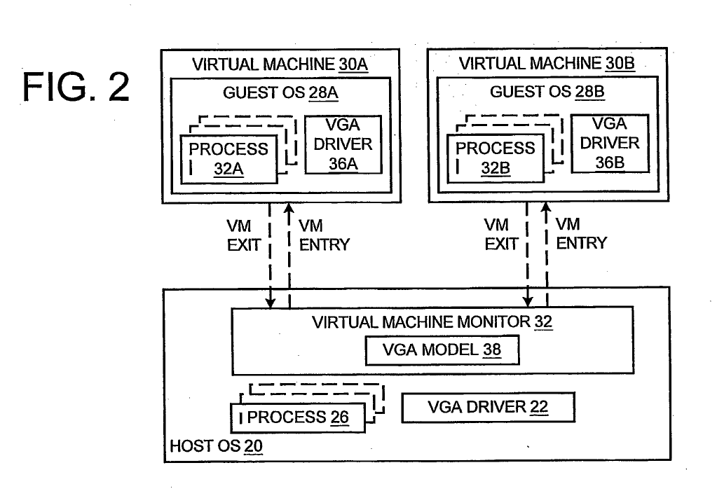

Reference is now made in addition to FIG. 2, which is a block diagram of a simplified exemplary architecture to execute at least one guest operating system while executing a host operating system in apparatus 4, according to some embodiments of the invention.

Two guest operating systems 28A and 28B are shown in FIG. 2, although any other number of guest operating systems is possible. Guest operating system 28A may be encapsulated by a VM 30A, and guest operating system 28B may be encapsulated by a VM 30B. One or more processes 32A may optionally be executed by processor 12 under the control of guest OS 28A. Similarly, one or more processes 32B may optionally be executed by processor 12 under the control of guest OS 28B.

Under the control of host OS 20, processor 12 may execute a VMM 32 to monitor and manage operations of virtual machines 24. For example, guest operating systems 28A and 28B may use logical addresses to access physical locations in memory 14. VMM 32 may partition memory 14 between host OS 20 and guest operating systems 28A and 28B, and may map the logical addresses of guest operating systems 28A and 28B into physical addresses of memory 14.

If guest OS 28A attempts to perform a “forbidden” operation, examples of which are given hereinbelow, the attempt may be sensed by VMX 27 of processor 12. VMX 27 may cause the execution of VM 30A to be interrupted, so that the forbidden operation is not executed by guest OS 28A. Instead, VM 30A may be exited (“VM exit”), and VMM 32 may take care of the forbidden operation instead of VM 30A (this exchange of roles is denoted “virtualization work”). After the virtualization work is completed, VMM 32 may transfer control to VM 30A (“VM entry”).

Similarly, if guest OS 28B attempts to perform a forbidden operation, the attempt may be sensed by VMX 27 of processor 12. VMX 27 may cause the execution of VM 30B to be interrupted, so that the forbidden operation is not executed by the guest OS 28B. Instead, VM 301 may be exited, and VMM 32 may take care of the forbidden operation instead of VM 30B. After the virtualization work is completed, VMM 32 may transfer control to VM 30B (“VM entry”).

A non-exhaustive list of examples for forbidden operations includes a page fault, access to a control register, access to an input/output (I/O) port by performing I/O instructions, and the like. Moreover, forbidden operations for which VMX 27 causes a “VM exit” may be programmable and/or selectable.

Guest operating systems 28A and 28B may include VGA drivers 36A and 36B, respectively, to interact with a VGA controller and to display image frames on a monitor. VGA drivers 36A and 36B may or may not be similar to VGA driver 22, and may or may not perform operations that are similar to operations performed by VGA driver 22.

However, in exemplary system 2, access to VGA controller 16 and monitor 6 may be restricted to VGA driver 22 of host OS 20. VMM 32 may include a VGA model 38, and VGA drivers 36A and 36B may be able to perform native VGA-related operations according to VGA model 38.

According to some embodiments of the invention, host OS 20 may partition image frame 24 into several sub-frames, and may assign sub-frames to selected respective operating systems. For example, as illustrated in FIG. 1, host OS 20 may partition image frame 24 into three sub-frames 40A, 40B and 40C, and may assign sub-frames 40A, 40B and 40C to guest OS 28A, guest OS 28B and host OS 20, respectively.

VGA model 38 may receive controls and image data from VGA drivers 36A and 36B, and may communicate with VGA driver 22 to display respective images in sub-frames 40A and 40B, respectively, on monitor 6.

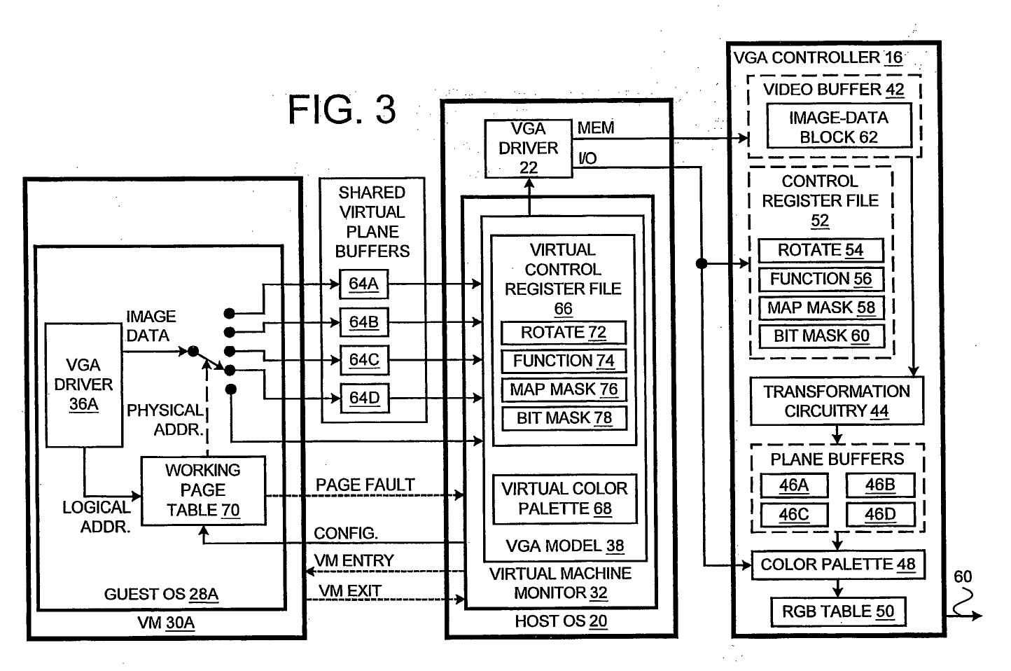

Reference is now made in addition to FIG. 3, which is a block diagram of a simplified exemplary architecture to provide VGA virtualization to one guest operating system in apparatus 4, according to some embodiments of the invention.

VGA controller 16 may include a video buffer 42, transformation circuitry 44, four bit-plane buffers 46A, 46B, 46C and 46D, a color palette 48, a red-green-blue (RGB) table 50 and a control register file 52. Control register file 52 may include at least a rotate register 54, a function register 56, a map mask register 58 and a bit mask register 60.

Video buffer 42 may be mapped for read and write operations in a memory address space of host OS 20 between, for example, physical memory-space addresses 0xA0000 and 0xC0000. In addition, control register file 52 and color palette 48 may be mapped for read and write operations in physical I/O-space addresses of host OS 20.

VGA controller 16 may receive an image-data block 62 from VGA driver 22, and may store it in video buffer 42. The size of image-data block 62 may be, for example, 8 Kilobytes. VGA controller 16 may be able to process image-data block 62 in transformation circuitry 44, according to the contents of control register file 52. A non-exhaustive list of examples for operations that VGA controller 16 may be able to perform on the image frame includes (in no particular order): a) rotation of bits of image-data block 62, controlled by rotation register 54; b) applying one or more than one functions to bits of image-data block 62, the functions may be selected by function register 56 and may involve latching of bits of image-data block 62; c) applying a map mask, defined by map mask register 58, to bits of image-data block 62; and d) applying a bit mask, defined by bit mask register 50, to bits of image-data block 62.

VGA controller 16 may be able to store the output of transformation circuitry 44 in one or more of bit-plane buffers 46A, 46B, 46C and 46D. According to the content of bit-plane buffers 46A, 46B, 46C and 46D, VGA controller 16 may select entries in color palette 48, and according to the selected entries in a color palette 48, VGA controller 16 may select entries in RGB table 50. VGA controller 16 may generate image frame 24 from the selected entries in RGB table 50, and may send image frame 24 via conductors 60 to monitor 6 to be displayed.

VGA controller 16 may be configured to the transparent plane configuration, in which VGA controller 16 does not rotate bits of image-data block 62, does not latch bits of data block 62, does not apply any function to image-data block 62, and does not apply a map mask to image-data block 62. In the transparent plane configuration, the content of bit mask register 60 determines which one of bit-plane buffers 46A, 46B, 46C and 46D is to store output of transformation circuitry 44.

Consequently, in the transparent plane configuration, image-data block 62 may be transparently transferred from video buffer 42 to the bit-plane buffer determined by the content of bit mask register 60. For example, if bit mask register 60 is configured to 0x0, 0x2, 0x4 or 0x8, image-data block 62 may be stored in bit-plane buffers 46A, 48B, 48C or 48D, respectively.

According to some embodiments of the invention, guest OS 28A and/or guest OS 28B may act to operate VGA controllers in the transparent plane configuration.

Guest OS 28A may allocate a range of logical memoly-space addresses for accessing a video buffer of a VGA controller. For example, guest OS 28A may allocate memory-space addresses 0XA0000 to 0xC0000 for this purpose. In addition, guest OS 28A may allocate logical I/O-space addresses for accessing a control register file and a color palette of a VGA controller. However, as previously mentioned, in exemplary system 2, direct access to VGA controller 16 may be forbidden to guest operating systems 28A and 28B.

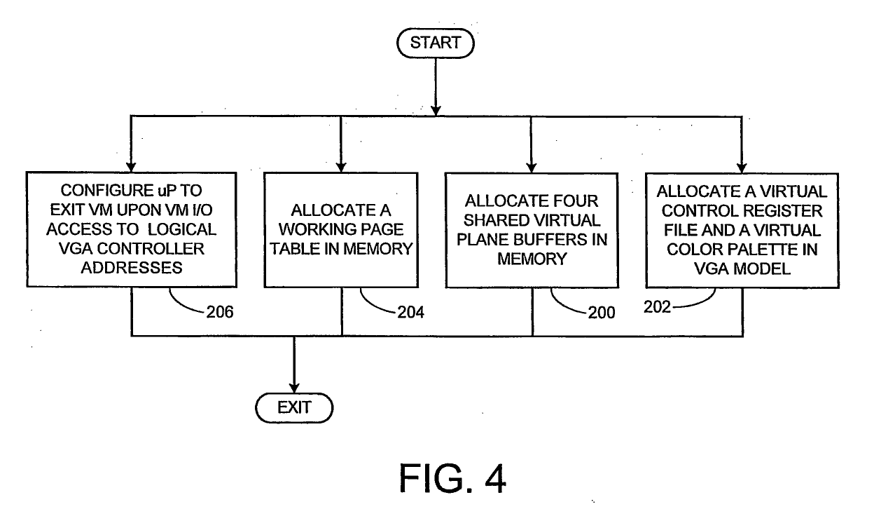

Reference is now made in addition to FIG. 4, which is a simplified flowchart illustration of part of an exemplary method for initialization for VGA virtualization, according to some embodiments of the invention.

VMM 32 may allocate four shared virtual plane buffers 64A, 64B, 64C and 64D in memory 14 (200). Guest OS 28A may be capable of writing to virtual plane buffers 64A, 64B, 64C and 64D, and VMM 32 may be capable of reading virtual plane buffers 64A, 64B, 64C and 64D.

In addition, VMM 32 may allocate a virtual control register file 66 and a virtual color palette 68 (202) in memory 14 to emulate a control register file and a color palette, respectively, of a VGA controller. Virtual control register file 66 may include at least a rotate register 72, a function register 74, a map mask register 76 and a bit mask register 78, substantially similar to rotate register 54, function register 56, map mask register 58 and bit mask register 60, respectively.

VMM 32 may be capable of writing to and reading from virtual control register file 66 and virtual color palette 68, and guest OS 28A may not be able to directly access virtual control register file 66 and virtual color palette 68.

Moreover, VMM 32 may allocate a working page table 70 (204) in memory 14. Working page table 70 may be configurable by VMM 32 to selectively re-map the logical memory-space addresses that guest OS 28A allocated for accessing a video buffer of a VGA controller into physical addresses of at least shared virtual plane buffers 64.

Furthermore, VMM 32 may configure processor 12 to execute “VM exit” from VM 30 upon accesses within guest operating systems 28A and 28B to logical I/O-space addresses that are allocated for accessing video buffers of VGA controllers (206).

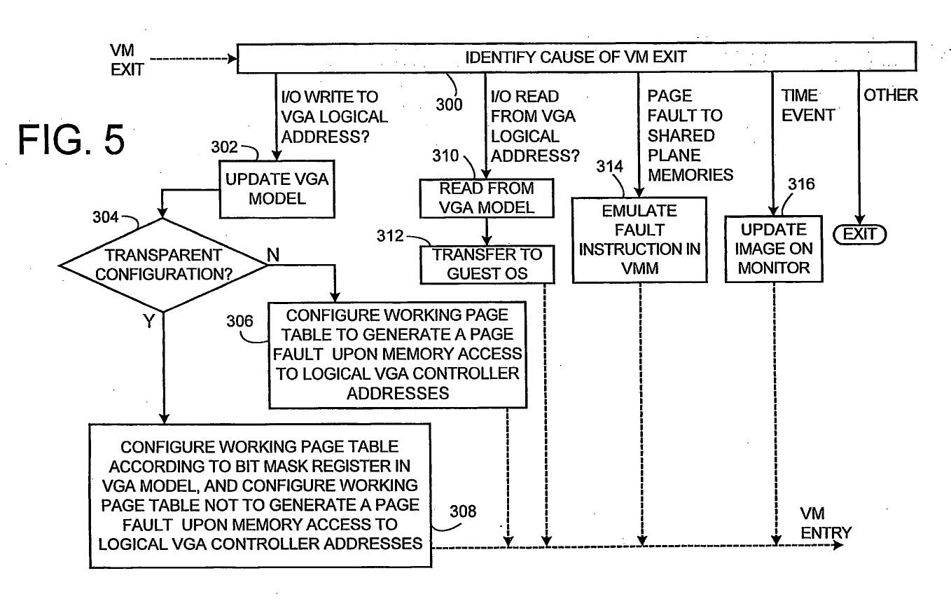

Reference is now made to FIG. 5, which is a simplified flowchart illustration of another part of an exemplary method for VGA virtualization, according to some embodiments of the invention.

Upon occurrence of a “VM exit”, VMM 32 may identify the cause for the “VM exit” (300). If the cause for “VM exit” was an attempt from within guest operating system 28A to write to an I/O-space address that is allocated for accessing a VGA controller, VMM 32 may update a register in virtual control register file 66 and/or virtual color palette 48 that corresponds to the register to which operating system 28A attempted to write (302).

VMM 32 may check whether virtual control register file 66 is programmed for a transparent plane configuration (304). If not, processor 12 may configure working page table 70 to generate a “page fault” upon accesses from within guest operating system 28A to memory-space addresses that are allocated in guest OS 28A for accessing a VGA controller (306), and may configure processor 12 to execute “VM exit” from VM 30A upon such a page fault. The method may exit by executing a VM entry.

However, if the content of virtual control register file 66 is programmed for a transparent plane configuration, VMM 32 may configure working page table 70 to re-map the logical memory-space addresses that guest OS 28A allocated for accessing a video buffer of a VGA controller into physical addresses of one of shared virtual plane buffers 64, according to the content of bit mask register 78 (308). In addition, processor 12 may configure working page table 70 not to generate a “page fault” upon accesses from within guest operating system 28A to memory-space addresses that are allocated in guest OS 28A for accessing a VGA controller. The method may exit by executing a VM entry.

If the cause for “VM exit” was an attempt from within guest operating system 28A to read from an I/O-space address that is allocated in guest OS 28A for accessing a VGA controller, VMM 32 may read the corresponding register from virtual control register file 66 or from virtual color palette 68 (310), and may transfer the value read to guest operating system 28A (312). The method may exit by executing a VM entry.

If the cause for “VM exit” was a page fault in response to an attempt from within guest operating system 28A to access a memory-space address that is allocated for accessing a video buffer of a VGA controller, VMM 32 may perform emulation of the instruction that caused the page fault (314). The method may exit by executing a VM entry.

VMM 32 may schedule time events for generating image frame 24 according to at least the content of shared virtual plane buffers 64, virtual control register file 66 and virtual color palette 68. In addition, processor 12 may be configured to exit VM 30A upon such a time event.

If the cause for “VM exit” was a time event, VMM 32 may generate image frame 24 according to at least the content of shared virtual plane buffers 64, virtual control register file 66 and virtual color palette 68 (316). The method may exit by executing a VM entry.

Only one guest OS is presented in FIGS. 3, 4 and 5 for clarity of the explanation. It is obvious to a person skilled in the art how to modify the explanations presented in FIGS. 3, 4 and 5 for a system including two or more guest operating systems.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

What is claimed is:

1. A method comprising:
interrupting an attempt by an operating system to program a video graphics array (VGA) controller of an apparatus to operate in a transparent plane configuration, said transparent plane configuration including a specification that a block of image data generated by said operating system is to affect content of a particular bit-plane of the VGA controller, where said operating system is prohibited by said apparatus from accessing said VGA controller; and
causing said operating system to store, without halting execution of said operating system, said block of image data in a particular buffer in a memory in response to an attempt by said operating system to store said block of image data in said VGA controller.

2. The method of claim 1, further comprising:
generating an image for display on a monitor controlled by said VGA controller from at least said particular buffer.

3. The method of claim 1, further comprising:
interrupting an attempt by said operating system to specify that a next block of image data generated by said operating system is to be transferred to a different bit-plane of said VGA controller; and
causing said operating system to store, without halting execution of said operating system, said next block of image data in another buffer in said memory in response to an attempt by said operating system to store said next block of image data in said VGA controller.

4. The method of claim 3, further comprising:
generating an image for display on a monitor controlled by said VGA controller from at least said particular buffer and said other buffer.

5. The method of claim 1, further comprising:
interrupting an attempt by said operating system to store control bits in said VGA controller; and
storing said control bits in said memory.

6. The method of claim 5, further comprising:
generating an image for display on a monitor controlled by said VGA controller from at least said buffer and said control bits.

7. The method of claim 1, wherein causing the operating system to store said block of image data in said particular buffer in said memory includes:
mapping logical addresses allocated by said operating system for accessing a video buffer of the VGA controller into physical addresses of said particular buffer.

8. The method of claim 1, further comprising:
allocating four buffers in said memory, including said particular buffer, to correspond to four bit-planes, including said particular bit-plane, of said VGA controller.

9. The method of claim 1, wherein said operating system is encapsulated in a virtual machine monitored by a virtual machine monitor, and the method further comprises:
exiting said virtual machine upon interrupting said attempt by said operating system to program said VGA controller;
updating a model of said VGA controller in said virtual machine monitor; and
re-entering said virtual machine.

10. An article comprising a storage medium having stored thereon instructions that, when executed by a processor, result in:
interrupting an attempt by an operating system to program a video graphics array (VGA) controller to operate in a transparent plane configuration, said transparent plane configuration including a specification that a block of image data generated by said operating system is to be transferred to a particular bit-plane of the VGA controller, where said operating system is prohibited from accessing said VGA controller; and
causing said operating system to store, without halting execution of said operating system, said block of image data in a particular buffer in a memory in response to an attempt by said operating system to store said block of image data in said VGA controller.

11. The article of claim 10, wherein said instructions further result in:
interrupting an attempt by said operating system to specify that a next block of image data generated by said operating system is to be transferred to a different bit-plane of said VGA controller; and
causing said operating system to store, without halting execution of said operating system, said next block of image data in another buffer in said memory in response to an attempt by said operating system to store said next block of image data in said VGA controller.

12. The article of claim 10, wherein said instructions further result in:
allocating four buffers in said memory, including said particular buffer, to correspond to four bit-planes, including said particular bit-plane, of said VGA controller.

13. An apparatus comprising:
a video graphics array (VGA) controller;
a processor to execute a virtual machine monitor and to execute an operating system encapsulated in a virtual machine monitored by said virtual machine monitor, said operating system prohibited from accessing said VGA controller; and
a memory to include four buffers corresponding to four bit-planes of said VGA controller,
wherein said virtual machine monitor is to identify an attempt by said operating system to program said VGA controller to operate in a transparent plane configuration and, in response to a subsequent attempt by said operating system to store a block of image data in said VGA controller, said virtual machine monitor is to cause said operating system to store said block of image data in one of said four buffers without halting execution of said operating system.

14. The apparatus of claim 13, wherein said processor has a virtual machine hardware extension (VMX) to provide communication between said virtual machine and said virtual machine monitor.

15. The apparatus of claim 13, wherein said virtual machine monitor is to maintain a model of said VGA controller, and wherein, in response to an attempt by said operating system to store control bits in said VGA controller, said virtual machine monitor is to store said control bits in said model.

16. The apparatus of claim 13, wherein said processor is to execute another operating system encapsulated in another virtual machine monitored by said virtual machine monitor.

17. The apparatus of claim 13, further comprising a monitor controlled by said VGA controller.

18. The apparatus of claim 13, further comprising an audio codec coupled to said processor.

19. The apparatus of claim 13, wherein said apparatus is a computer.

20. A system comprising:
a monitor; and
an apparatus including at least:
a video graphics array (VGA) controller;
a processor to execute a virtual machine monitor and to execute an operating system encapsulated in a virtual machine monitored by said virtual machine monitor, said operating system prohibited from accessing said VGA controller; and
a memory to include four buffers corresponding to four bit-planes of said VGA controller,
wherein said virtual machine monitor is to identify an attempt by said operating system to program said VGA controller to operate in a transparent plane configuration and, in response to a subsequent attempt by said operating system to store a block of image data in said VGA controller, said virtual machine monitor is to cause said operating system to store said block of image data in one of said four buffers without halting execution of said operating system.

21. The system of claim 20, wherein said processor has a virtual machine hardware extension (VMX) to provide communication between said virtual machine and said virtual machine monitor.

22. The system of claim 20, wherein said virtual machine monitor is to maintain a model of said VGA controller, and wherein, in response to an attempt by said operating system to store control bits in said VGA controller, said virtual machine monitor is to store said control bits in said model.

23. The system of claim 20, wherein said processor is to execute another operating system encapsulated in another virtual machine monitored by said virtual machine monitor.

24. The system of claim 20, further comprising an input device coupled to said processor.

25. The system of claim 20, wherein said apparatus further includes an audio codes coupled to said processor, said system further comprising an audio device coupled to said audio codec.

26. The system of claim 20, wherein said apparatus is a computer.
